(19) United States
(12) Patent Application Publication
(10) Pub. No.: US 2007/0260784 A1
(43) Pub. Date: Nov. 8, 2007

(54) Microprocessor system

(75) Inventors: Yasushi Takamatsu, Yokohama (JP); Akira Okawa, Yokohama (JP); Noriyuki Uenishi, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/512,333

(22) Filed: Aug. 30, 2006

(30) Foreign Application Priority Data
Mar. 24, 2006 (JP) 2006-082317

(51) Int. Cl. G06F 13/38

(52) U.S. Cl. 710/62

(57) ABSTRACT

A multiprocessor system, in which a memory card can be easily accessed from a data processor other than a data processor to which the memory card is connected without impeding processing, has been disclosed. The multiprocessor system comprises data processors wherein a first data processor comprises a memory card interface, a first communication interface, and a first buffer, and another data processor comprises a second communication interface, and when the other data processor reads data from the memory card, the first data processor transmits data after reading the data of the memory card in accordance with the condition of processing and storing the data temporarily in the first buffer and, when the other data processor writes data to the memory card, the first data processor stores the data from the other data processor in the first buffer irrespective of the condition of processing of the first data processor and writes the data to the memory card in accordance with the condition of processing.

### BACKGROUND OF THE INVENTION

The present invention relates to a multiprocessor system in which processors are connected by a communication interface and, more particularly, to a multiprocessor system in which a memory card interface for accessing a memory card is provided for one processor.

In a computer system used in a conventional mobile phone, every process was performed by one data processor. For example, one processor would perform control of communication, control of hardware such as an RF circuit, an LCD, memory parts, etc., processing of an application, etc. However, following recent mobile phone developments which offer higher performance and advanced functions, in order for one data processor to perform every process, it is necessary to use a data processor having a high operating frequency and a high performance, resulting in a problem that power consumption is increased and that the battery life of a battery-driven mobile phone is reduced.

Because of this, a multiprocessor system having a plurality of processors is used and the main processing, such as control of communication, is performed by one data processor and processing of an application etc. that cannot be performed by the first data processor is performed by another data processor. When a plurality of data processors are mounted in one system, a common bus is frequently used for connection between data processors, however, for a data processor that cannot share a bus or when a sufficient performance is not obtained if a bus is shared, it is necessary to incorporate an external interface in one data processor and connect the bus of another data processor to this interface for data transmission. The data transmission is performed by using RAM incorporated in the data processor and an interrupt function, however, it is necessary to execute software in order to use the transmitted data. Therefore, an interrupt program is executed for each data transmission and the processing of a program being executed is stopped as a result. Therefore, WO02/061591A1 has described a system in which peripheral functions connected to an internal bus of one data processor can be operated directly by another data processor.

FIG. 1 is a diagram showing the hardware configuration of a conventional system, as described in WO02/061591A1, and also showing an example in which another processor performs a function of recording or playing back video information. As shown schematically, the system in WO02/061591A1 is constituted by two data processors, that is, a data processor 1A and a data processor 1B. The data processor 1A has a CPU 2A, an internal bus 3A, a RAM 4A, a memory card interface 5 for accessing a memory card 9 to be connected, and an external interface 6. The other data processor 1B has a CPU 2B, an internal bus 3B, a RAM 4B, a video processing section 7 for performing encoding and decoding of video data, and an audio processing section 8 for performing encoding and decoding of audio data. The data processors 1A and 1B have various peripheral functions in addition to the above, however, these are omitted here. The external interface 6 is connected to the internal bus 3A and, at the same time, is connected to the internal bus 3B of the data processor 1B via an external bus 10. The external interface 6 is provided with a function of enabling connection of the other data processor 1B to the internal bus 3A of the data processor 1A as a bus master, thereby, it is possible for the other data processor 1B to directly operate a peripheral function memory-mapped to the internal bus 3A such as, for example, a memory card interface 5. The video processing section 7 performs encoding and decoding of, for example, video data in MPEG4 format. The audio processing section 8 performs encoding and decoding of, for example, audio data in MP2 format.

FIG. 2 is a diagram showing the software structure of the conventional system in FIG. 1. As shown schematically, the data processor 1A has a memory card interface (IF) section 11A, which is a program for accessing the memory card 9 via the memory card interface 5, a file multiplexing section 12A for multiplexing a file including the case where a file is generated within the memory card 9, and a file management section 13A for managing files. In actuality, the data processor 1A has other various kinds of software, however, they are omitted here because they do not relate directly to the present invention. Similar to the data processor 1A, the data processor 1B has a memory card interface (IF) section 11B, a file multiplexing section 12B, and a file management section 13B and, further, has a video code (VC) control section 14 for controlling the video processing section 7 that performs encoding and decoding of video data and an audio code (AC) control section 15 for controlling the audio processing section 8 that performs encoding and decoding of audio data. The file multiplexing sections 12A and 12B multiplex a file in accordance with the rule of each file format (Dynamic image: AVI format, MP4 format. Static image: JPEG format etc.) or demultiplexes a file. The file management sections 13A and 13B manage files including those on the memory card 9 and the main processes thereof are, for example, initializing, starting file creation, ending file creation, deleting, write to a file, read from a file, etc. With the above-mentioned configuration, the memory card IF section 11B also directly accesses the memory card 9 via the memory card interface 5 and it is possible for the file multiplexing section 12B to create a file not only in the data processor 1B but also in the memory card 9.

FIG. 3 is a diagram for explaining the flow of data when the data processor 1B performs a write operation, of recorded data, to the memory card 9 in the above-mentioned conventional system. In the figure, the arrows show the flow of data and data flows in order of a and b. For example, the video processing section 7 encodes image data inputted from a CCD etc. into MPEG4 and the audio processing section 8 encodes PCM data inputted from a microphone etc. into MP2, and both are multiplexed into an AVI file in real time, respectively. The multiplexed data is stored in the RAM 4B as shown by the arrow a and is further written to a file on the memory card 9, from the RAM 4B and at any time, via the external interface 6 and the memory card interface 5 as shown by the arrow b. This write operation is performed after the data processor 1B requests to use the internal bus 3A of the data processor 1A via the external interface 6 and, in response to this, the CPU 2A of the data processor 1A issues a bus grant signal.

FIG. 4 is a diagram for explaining the flow of data when the data processor 1B performs the operation of reading data, from the memory card 9, for playing back in the above-mentioned conventional system and the data flows in order of the arrows c and d. The flow of data in FIG. 4 is opposite to that in FIG. 3 and this read operation is also performed after the data processor 1B requests to use the internal bus 3A of the data processor 1A via the external interface 6 and in response to this, the CPU 2A of the data processor 1A issues a bus grant signal.

### SUMMARY OF THE INVENTION

In the conventional system explained with reference to FIG. 1 to FIG. 4, if the data processor 1B requests to use the internal bus 3A of the data processor 1A. In order to use the internal bus 3A as a bus master, it is necessary for the data processor 1A to temporarily stop the processing being performed and assign the internal bus 3A to the data processor 1B and there was a problem that the processing of the data processor 1A is impeded. For example, when an AVI file is large, it takes much time to transmit it and, in the meantime, the data processor 1A cannot perform urgent processing etc. as a result.

In order to access the memory card 9 from the data processor 1B 9 in the conventional system, it is necessary to create a file on the memory card 9. Creation of a file is easy as long as the internal bus 3A can be used continuously by the data processor 1B. However, the processing becomes complex when, for example, processing is performed in which the grant of the internal bus 3A to the data processor 1B can be stopped at any time in order to solve the problem of the continuous use of the internal bus 3A by the data processor 1B as described above.

Further, in the conventional system, when the memory card 9 is used both by the data processor 1A and by the data processor 1B, it is necessary to provide a mechanism for managing files (the file management sections 13A and 13B) in both the data processor 1A and in the data processor 1B as shown in FIG. 2. Because of this, processing such as synchronization of information for file management and exclusion of processing is required and there arises a problem that the system becomes complex.

An object of the present invention is to solve the above-mentioned problems and to realize a multiprocessor system in which it is possible for a data processor other than the data processor to which a memory card is connected to easily access the memory card without this impeding processing.

In order to realize the above-mentioned object, a multiprocessor system in a first aspect of the present invention is provided with a communication interface having a buffer RAM in each data processor, wherein the data processor to which a memory card is connected temporarily stores transmission data in the buffer RAM when an access to the memory card is requested from another data processor. After this, the load condition of an internal bus is monitored and when the condition become such that the load is light, the data is transmitted from the buffer RAM to a buffer RAM of the communication interface of another data processor. As soon as the transmission operation is completed, permission for the next data transmission is given. In this manner, the data processor to which the memory card is connected is characterized by adjustment of timing with which data is communicated in accordance with the condition of the internal bus.

In a multiprocessor system in a second aspect of the present invention, a data processor to which a memory card is connected is provided with an access section for performing processing to access the memory card, another data processor is provided with an access control section for performing processing to access the memory card, and when the other data processor accesses the memory card, the access section of the data processor to which the memory card is connected is activated from the access control section via a communication interface and thereby, the memory card is accessed indirectly via the access section.

A multiprocessor system in a third aspect of the present invention is characterized in that a data processor to which a memory card is connected is provided with a file management section for managing files on the memory card and when the file on the memory card is accessed by another data processor, a command for activation is sent to the file management section of the data processor to which the memory card is connected. In other words, the present aspect is characterized in that a mechanism to manage files on the memory card is provided in one data processor and another data processor accesses this file management mechanism.

In the case where the file management mechanism (file system) is provided only in the data processor to which the memory card is connected, when another data processor accesses, via the memory card interface of the data processor to which the memory card is connected, the file on the memory card located ahead thereof, the contents (the ID and offset address of the desired file, the contents of the request, such as read and write) are exchanged on a command basis via the communication interface and an instruction (command) is issued from the other data processor to the data processor to which the memory card is connected. The data processor to which the memory card is connected is configured so as to perform processing for the request and to send back the result (in the case of read: data read from the file, in the case of write: the written result etc.) via the communication interface.

According to the present invention, the other data processor is capable of also creating a file on the memory card connected to another data processor.

The present invention can be applied to a system in which two or more data processors are connected to a data processor to which the memory card is connected via a communication path.

According to the multiprocessor system in the first aspect of the present invention, it is possible for the data processor to which the memory card is connected to reduce or adjust the load on the internal bus caused by an access request to the memory card of the other data processor by performing data communication while monitoring the load condition of the internal bus.

According to the multiprocessor system in the second aspect of the present invention, it is possible to easily perform an access to the file on the memory card from a data processor other than the data processor to which the memory card is connected, to create a file in real time from another data processor, and to obtain the file. This effect applies in a system in which two or more data processors are connected to the data processor to which the memory card is connected.

According to the multiprocessor system in the third aspect of the present invention, it is possible to use a common file management mechanism in a system configured by a plurality of data processors.

Furthermore, according to the present invention, it is possible for another data processor connected to the data processor to which the memory card is connected via a communication path to create and access a file on the memory card. Due to this, it is possible to configure a mobile terminal etc. having a recording/playing back system of a dynamic image by a simple multiprocessor system.

### BRIEF DESCRIPTION OF THE DRAWINGS

The features and advantages of the invention will be more clearly understood from the following description taken in conjunction with the accompanying drawings, in which:

FIG. 1 is a diagram showing a hardware configuration of a conventional system;

FIG. 2 is a diagram showing a software structure of a conventional system;

FIG. 3 is a diagram showing the flow of data in a write operation during a period of recording in a conventional system;

FIG. 4 is a diagram showing the flow of data in a read operation during a period of playing back in a conventional system;

FIG. 5 is a diagram showing a hardware configuration of a system in an embodiment of the present invention;

FIG. 6 is a diagram showing a communication interface configuration of a system in an embodiment;

FIG. 7 is a diagram showing a software structure of a system in an embodiment;

FIG. 8 is a diagram showing a write operation during a period of recording in a system in an embodiment;

FIG. 9 is a diagram showing the flow of data in a write operation during a period of recording in a conventional system;

FIG. 10 is a diagram showing a read operation during a time of playing back in a system in an embodiment;

FIG. 11 is a diagram showing the flow of data in a read operation during a period of playing back in a system in an embodiment;

FIG. 12A and FIG. 12B are diagrams showing a processing sequence (file create) during a period of recording in a system in an embodiment;

FIG. 13A and FIG. 13B are diagrams showing a processing sequence (file write) during a period of recording in a system in an embodiment; and

FIG. 14A and FIG. 14B are diagrams showing a processing sequence (file close) during a period of recording in a system in an embodiment.

### DESCRIPTION OF THE PREFERRED EMBODIMENTS

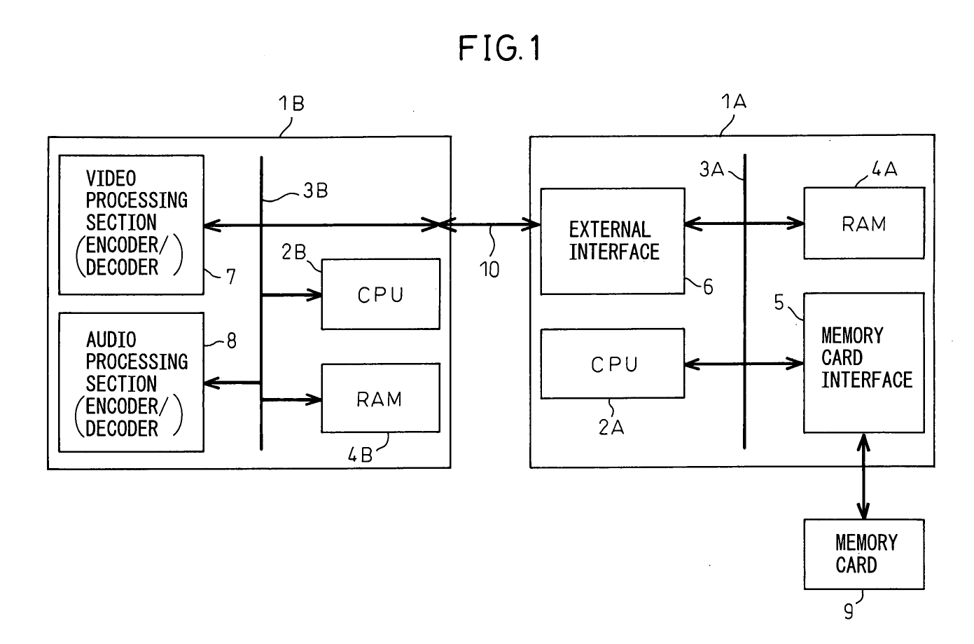

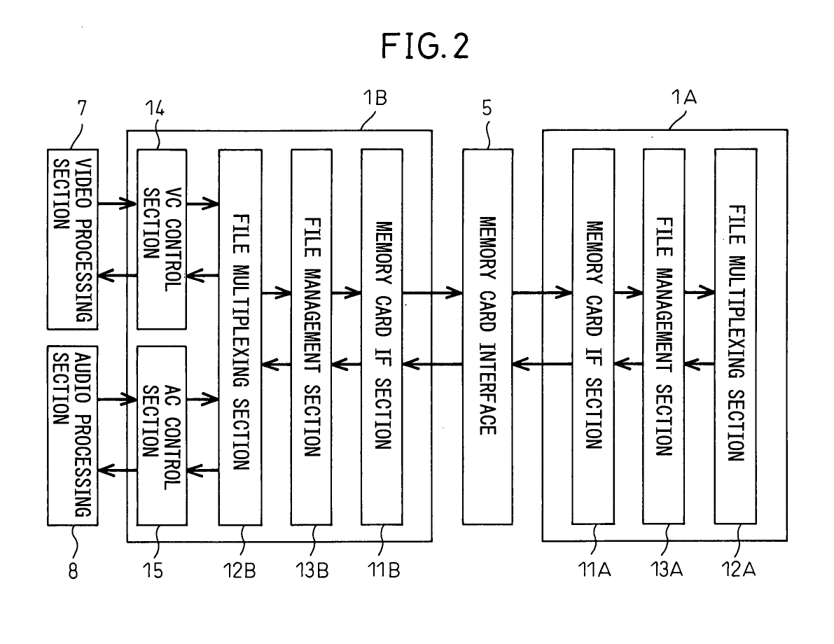

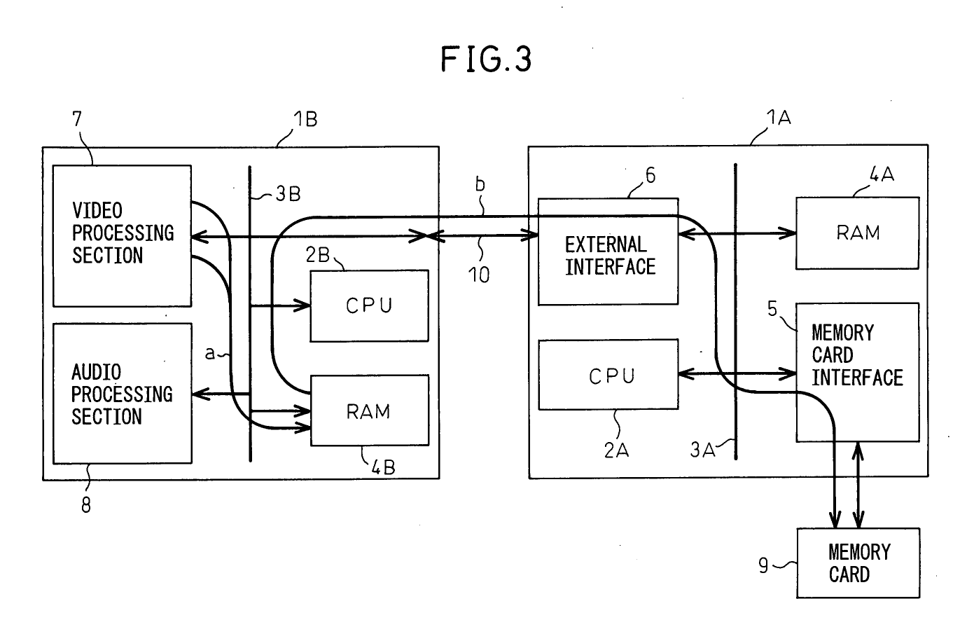

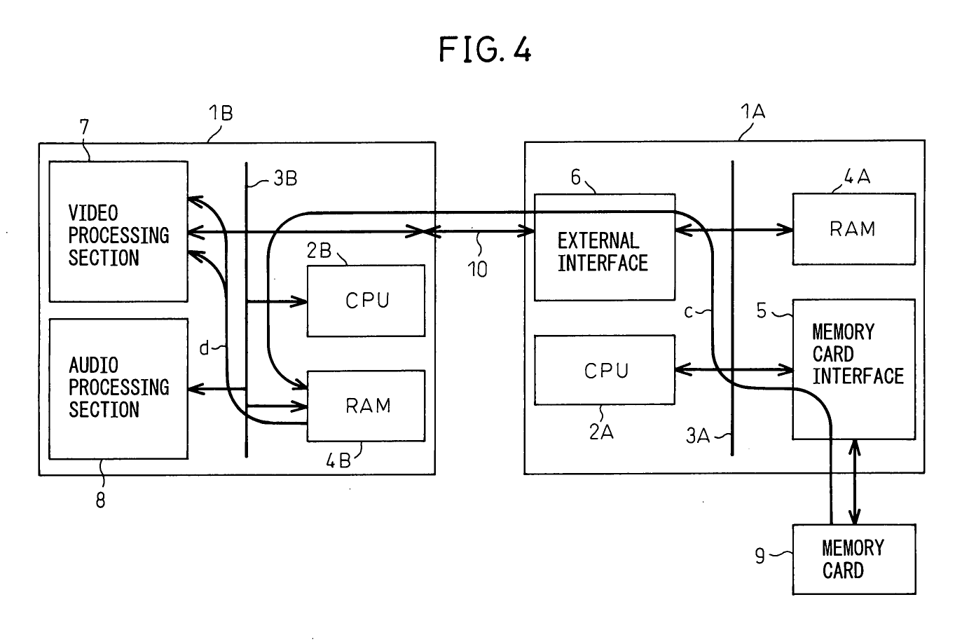

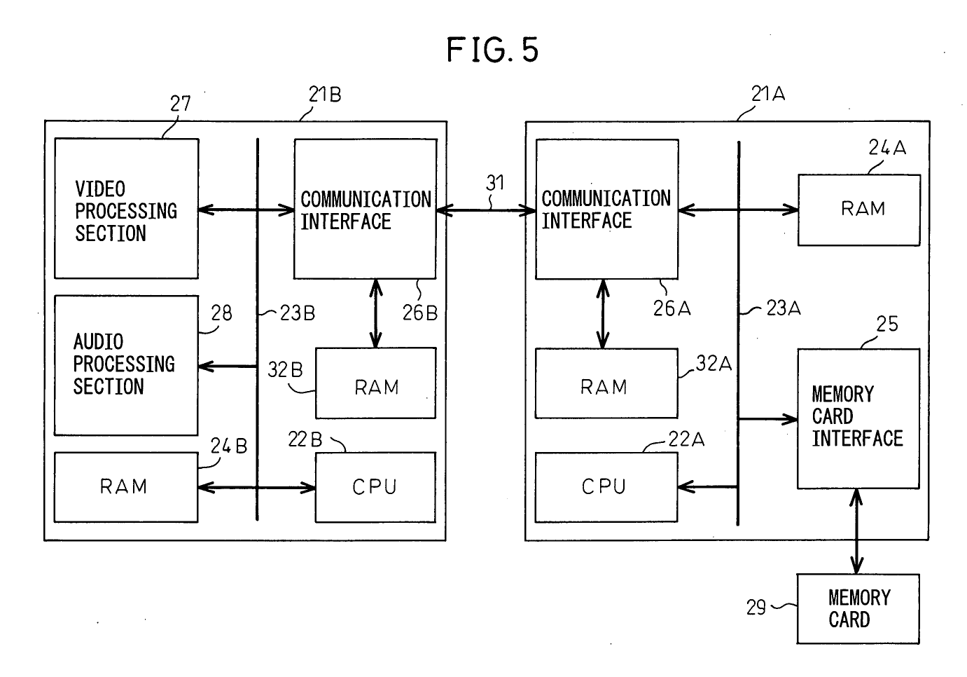

FIG. 5 is a diagram showing a hardware configuration of a multiprocessor system in an embodiment of the present invention. As shown schematically, the system in the embodiment is configured by two data processors, that is, a data processor 21A and a data processor 21B. The data processor 21A, which is one of the data processors, has a CPU 22A, an internal bus 23A, a RAM 24A, and a memory card interface 25 with a memory card 29, and the data processor 21B, which is the other of the data processors, has a CPU 22B, an internal bus 23B, a RAM 24B, a video processing section 27, and an audio processing section 28. The configuration described above is the same as that of the conventional example in FIG. 1.

In the system in the embodiment, the data processor 21A is provided with a communication interface 26A instead of the external interface 6, the data processor 21B is provided with a communication interface 26B, and the communication interfaces 26A and 26B are connected by a communication path 31. In the present embodiment, data is exchanged through the communication path 31 in a handshake routine using a communication interface such as a serial communication interface, however, a parallel communication interface etc. can also be used. Further, to the communication interfaces 26A and 26B, a RAM 32A and a RAM 32B are directly connected, respectively. The communication interfaces 26A and 26B have the same configuration. The CPUs 22A and 22B can access the respective RAMs 24A and 24B directly, however, they can access the RAMs 32A and 32B only via the communication interfaces 26A and 26B, that is, cannot access them directly.

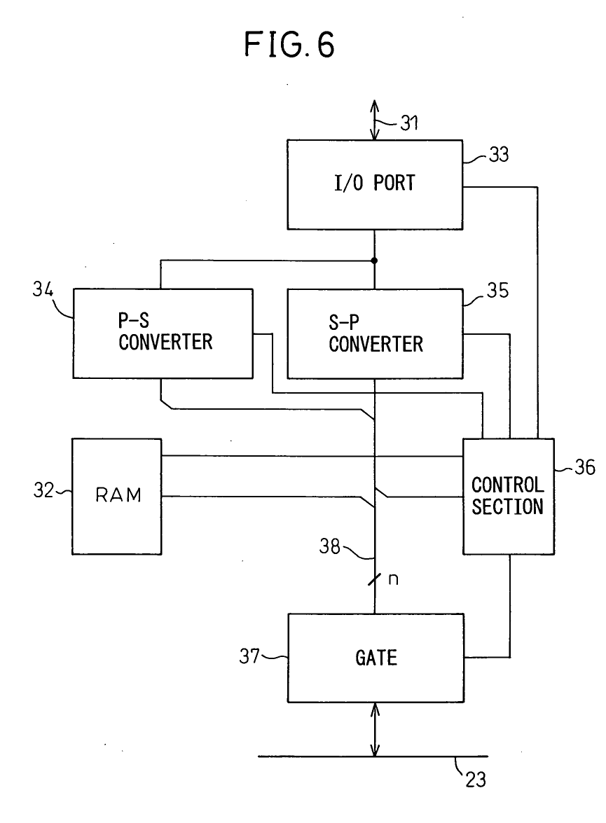

FIG. 6 is a diagram showing a configuration of the communication interfaces 26A and 26B. As shown schematically, the communication interface has an I/O port 32 connected to the communication path 31, a parallel-serial (P-S) converter 34 that latches n-bit data of a bus 38, converts the data into one-bit data, and outputs the data to the I/O port 33, a serial-parallel (S-P) converter 35 that converts one-bit data from the I/O port 33 into n-bit data and outputs the data to the bus 38, a gate provided between an internal bus 23 corresponding to the internal bus 23A or 23B and the bus 38, and a control section 36 for controlling each part. A RAM 32 corresponding to the RAM 32A or 32B is connected to the bus 38.

In FIG. 6, when the communication interface receives data from the communication path 31, the S-P converter 35 converts the data received by the I/O port 33 into n-bit data, outputs the data to the bus 38, and temporarily stores the data in the RAM 32. Then, when the load of the internal bus 23 is light, the data is read from the RAM 32 and outputted to the internal bus 23 via a gate 37. When the communication interface transmits data to the communication path 31, the data outputted to the internal bus 23 is stored temporarily in the RAM 32 via the gate 37. Then, the data is read from the RAM 32 and the n-bit data is converted into one-bit data by the S-P converter 35, and the data is outputted from the I/O port 33 to the communication path 31.

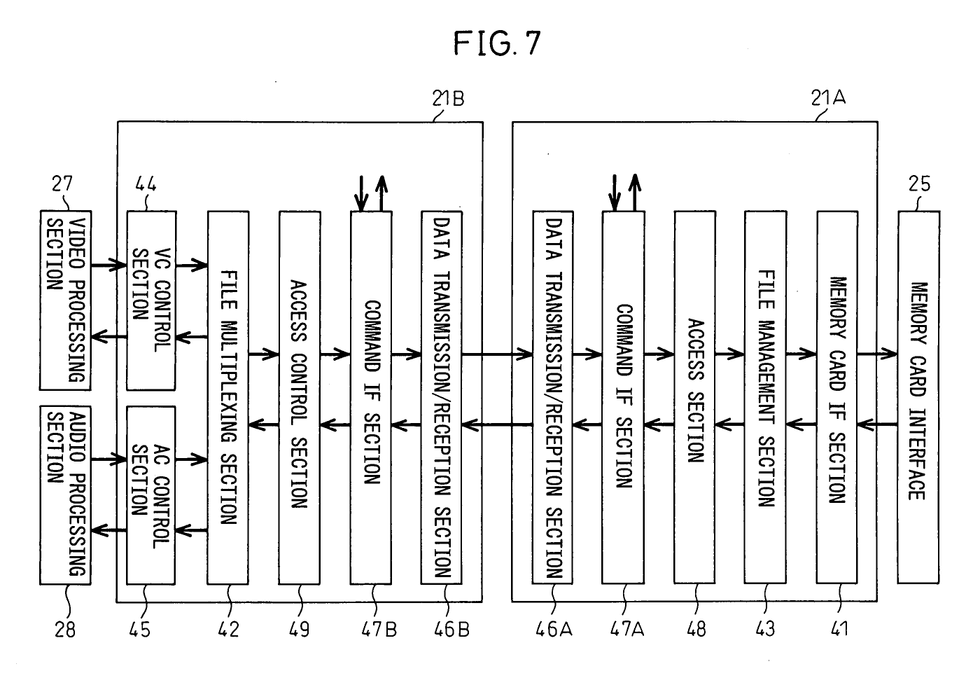

FIG. 7 is a diagram showing a software structure of a system in the embodiment. As shown schematically, the data processor 21A controls the memory card interface 25 and has a memory card interface (IF) section 41A, which is a program for accessing a file on the memory card 29, a file management section 43 for managing files including files on the memory card, a data transmission/reception section 46A for controlling the communication interface 26A, a command interface (IF) section 47A for analyzing a command from the data processor 21B and creating a command, and an access section 48 for controlling an access to the memory card IF section 41. The data processor 21B has a file multiplexing section 42 for multiplexing a file including files on the memory card, a VC control section 44 for controlling the video processing section 27, an AC control section 45 for controlling the audio processing section 28, a data transmission/reception section 46B for controlling the communication interface 26B, a command interface (IF) section 47B for analyzing a command from the data processor 21A and creating a command, and an access control section 49 for controlling access to the memory card IF section 41 via the access section 48.

The data transmission/reception sections 46A and 46B realize communication between processors by controlling the communication interfaces 26A and 26B, respectively. The data transmission/reception sections 46A and 46B communicate data, such as parts of a file, and a command. A command is used to direct processing and notify the condition between processors.

The command IF sections 47A and 47B transmit an instruction or a notification from each portion to another data processor as a command. Further, the command IF sections 47A and 47B receive a command from the other data processor, judge the contents of the command, and notify each portion of that. In the case of a command involving an exchange of data, data is transmitted after a command is transmitted and data is received after the command is received.

The file multiplexing section 42 multiplexes a file in accordance with the rule of each file format (Dynamic image: AVI format, MP4 format. Static image: JPEG format etc.) or demultiplexes a file.

The file management section 43 manages files including those on the memory card 9 and the main processing contents thereof are, for example, initializing, starting file creation, ending file creation, deleting, write to a file, read from a file, etc.

The access control section 49 issues an instruction to the file management section 43 in accordance with an instruction from the file multiplexing section 42 and performs processing to the file on the memory card 29. Because it is not possible to issue an instruction directly to the file management section 43, the access control section 49 remotely issues an instruction to the access section 48 using communication between data processors, issues an instruction to the file management section 43 from the access section 48, and performs each process. An instruction from the access control section 49 to the access section 48 is performed by a command.

The access section 48 issues an instruction to the file management section 43 in accordance with an instruction of the access control section 49 and performs each process.

With the hardware configuration and software structure described above, in the system of the embodiment, an AVI file is formed in the memory card 29, the data processor 21B accesses the file indirectly to carry out a processing to record/play back a dynamic image file, however, the processing is shared as follows.

[Write Operation During the Period of Recording]

The data processor 21A writes a file in real time to the memory card 29 through the file management section 43 for managing files and the memory card IF section 41 and via the memory card interface 25. The data processor 21A also manages files on the memory card 29.

The data processor 21B encodes RGB image data from the CCD etc. into MPEG4, encodes audio data in the PCM code into MP2 and multiplexes the data. However, writing to the file on the memory card 29 etc. is performed by the data processor 21A.

[Read Operation During the Period of Playing Back]

The data processor 21A reads a file on the memory card in real time through the file management section 43 for managing files and the memory card IF section 41 and via the memory card interface 25.

The data processor 21B demultiplexes a file on the memory card 29, decodes data in MPEG4 into YUV image data, and decodes data in MP2 into audio data in PCM code. However, reading from a file on the memory card etc. is performed by the data processor 21A.

The write operation during the period of recording and the read operation during the period of playing back are explained in detail below.

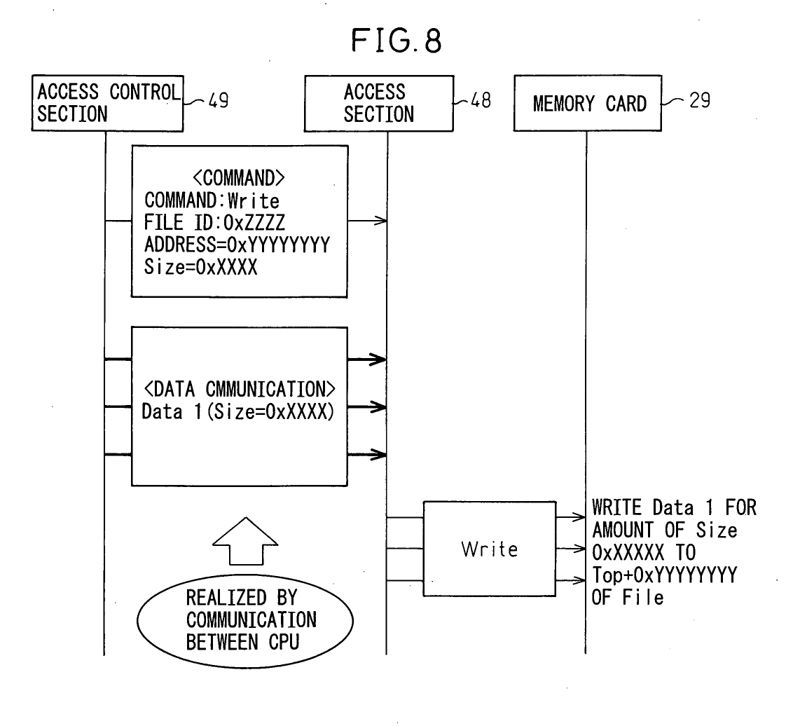

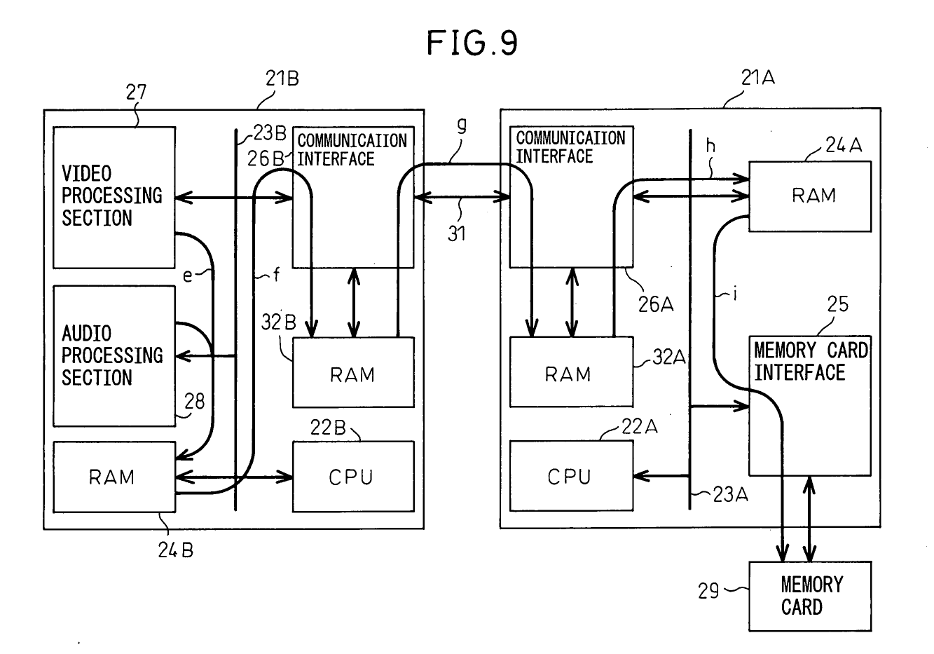

FIG. 8 is a diagram showing an exchange of signals between the access control section 49 of the data processor 21B, the access section 48 of the data processor 21A, and the memory card 29 in the write operation during the period of recording. FIG. 9 is a diagram showing the flow of data in the write operation during the period of recording and data flows in order from e to i.

As shown by the arrow e, the MPEG4 data encoded in the video processing section 27 and the MP2 data encoded in the audio processing section 28 are multiplexed in accordance with information for MUX processing in the file multiplexing section 42 of the data processor 21B using the RAM 24B as a work memory. As shown by the arrow f, the data having been subjected to MUX processing is stored sequentially in the RAM 32B via the communication interface 26B.

As shown by the arrow g, the data having been subjected to MUX processing and stored in the RAM 32B is transmitted to the RAM 32A via the communication interface 26B, the communication path 31, and the communication interface 26A. As shown in FIG. 8, the data is transmitted by data communication after the information (file data, offset address on the file, etc.) of the file multiplexing section 42 is transmitted from the access control section 49 of the data processor 21B to the access section 48 of the data processor 21A as a “command” via the command IF section 47B, the data transmission/reception section 46B, the data transmission/reception section 46A, and the command IF section 47A.

As shown by the arrow h, the data having been subjected to MUX processing and stored in the RAM 32A is transmitted to the RAM 24A when the condition is such that the load of the internal bus 32A of the data processor 21A is light, as shown by the arrow h, then, as shown by the arrow i, the data is transmitted from the RAM 24A to the memory card 29 via the memory card interface 25 (refer to FIG. 8 and FIG. 9). By the way, it is also possible to transmit the data from the RAM 32A to the memory card 29 via the memory card interface 25 and not via the RAM 24A.

In the manner described above, the data of the file having been subjected to MUX processing in the data processor 21B is written to the file on the memory card 29 by the data processor 21A.

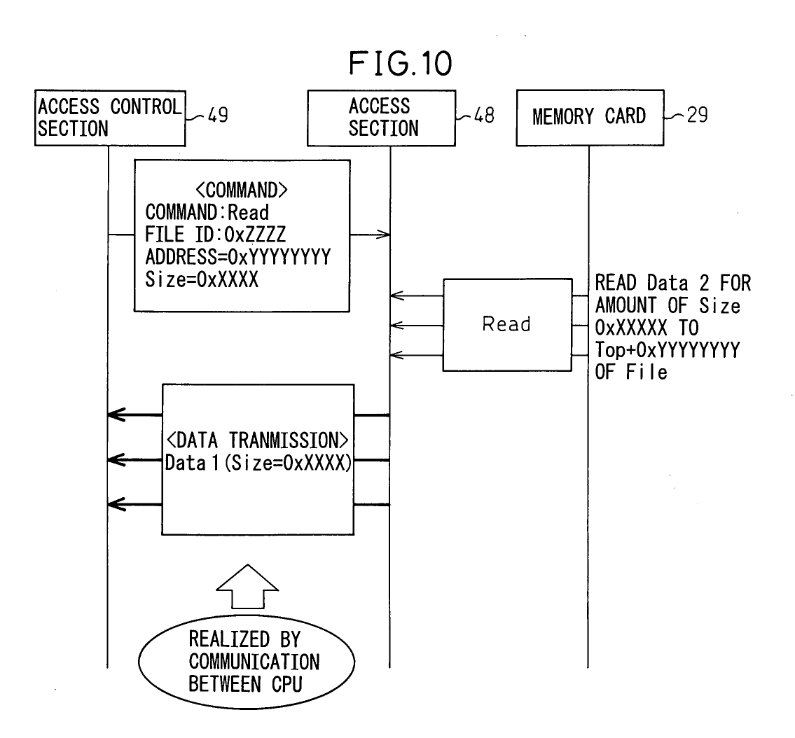

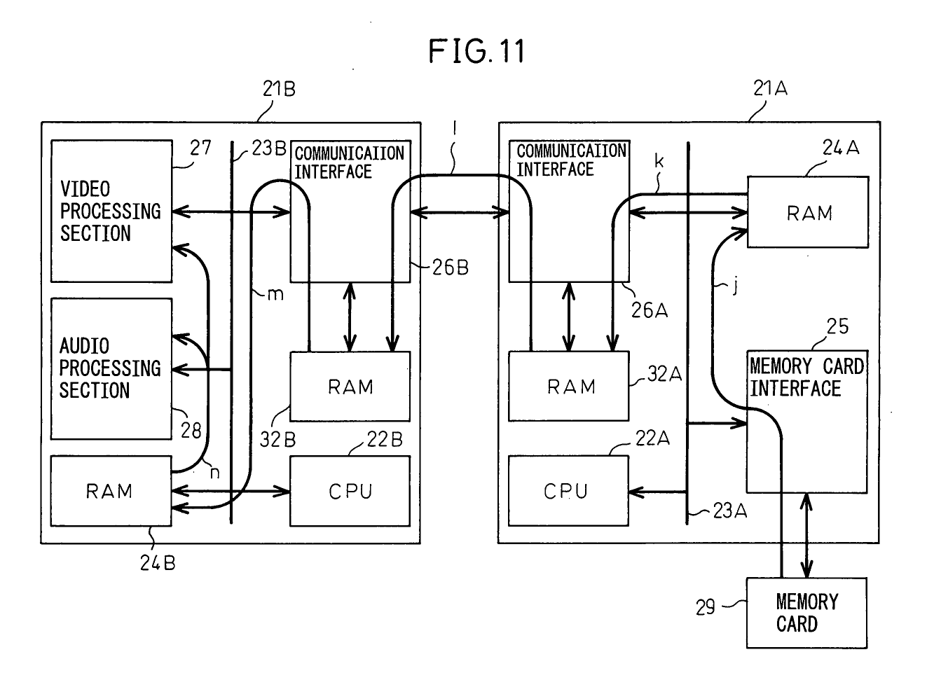

Next, the read operation during the period of playing back is explained below. FIG. 10 is a diagram showing an exchange of signals between the access control section 49 of the data processor 21B, the access section 48 of the data processor 21A, and the memory card 29 in the read operation during the period of playing back. FIG. 11 is a diagram showing the flow of data in the read operation during the period playing back and the data flows in order from j to n.

When data to be played back is read from the memory card 29, as shown in FIG. 10, the information (file data, offset address on the file, etc.) of the file multiplexing section 42 is transmitted from the access control section 49 of the data processor 21B to the access section 48 of the data processor 21A as a “command” via the command IF section 47B, the data transmission/reception section 46B, the data transmission/reception section 46A, and the command IF section 47A. Specifically, the command transmission is performed by transmitting a “command” from the access section 48 of the data processor 21A to the access control section 49 of the data processor 21B via the command IF section 47A, the data transmission/reception section 46A, the data transmission/reception section 46B, and the command IF section 47B.

In response to this, the data processor 21A reads the specified data from the memory card 29 via the memory card interface 25 as shown by the arrow j when the condition is such that the load of the internal bus 23A is light and transmits the data to the RAM 24A, and further, as shown by the arrow k, the data processor 21A transmits the data to the RAM 32A via the communication interface 26A. By the way, it is also possible to transmit data from the memory card 29 to the RAM 32A via the memory card interface 25 and not via the RAM 24A. The data to be read is the data having been subjected to MUX processing.

As shown by the arrow 1, the data transmitted to the RAM 32A is transmitted to the RAM 32B via the communication interface 26A, the communication path 31, and the communication interface 26B.

Next, as shown by the arrow m, the data of the RAM 32B is transmitted to the RAM 24B. The data having been subjected to MUX processing and transmitted to the RAM 24B is demultiplexed into the data in MPEG4 and MP2 in the file multiplexing section 42. As shown by the arrow n, the video processing section 27 and the audio processing section 28 access the MPEG4 and MP2 data stored in the RAM 24B and generate a playing back signal (YUV image data and PCM audio data) by decoding the data.

Table 1 shows an example of a command issued from the access control section 49 of the data processor 21B.

TABLE 1
Example of a command issued from an access
control section in the invention

| | NAME OF | |
|---|---|---|
| NO. | COMMAND | EXPLANATION |
| 1 | CREATE | REQUEST A CREATE (FILE CREATING) |
| | | PROCESS TO A FILE MANAGEMENT SECTION |
| | | OF A DATA PROCESSOR 21A |
| 2 | OPEN | REQUEST AN OPEN (FILE CREATING START) |
| | | PROCESS TO A FILE MANAGEMENT SECTION |
| | | OF A DATA PROCESSOR 21A |
| 3 | CLOSE | REQUEST A CLOSE (FILE CREATING STOP) |
| | | PROCESS TO A FILE MANAGEMENT SECTION |
| | | OF A DATA PROCESSOR 21A |
| 4 | DELETE | REQUEST A DELETE (FILE DELETE) PROCESS |
| | | TO A FILE MANAGEMENT SECTION OF A |
| | | DATA PROCESSOR 21A |
| 5 | WRITE | REQUEST A WRITE (FILE WRITE) PROCESS |
| | | TO A FILE MANAGEMENT SECTION OF |
| | | A DATA PROCESSOR 21A AND SENDS WRITE |
| | | DATA BY “DATA TRANSMISSION” |
| 6 | READ | REQUEST A READ (FILE READ) PROCESS TO |
| | | A FILE MANAGEMENT SECTION OF A DATA |
| | | PROCESSOR 21A AND RECEIVES READ DATA |
| | | BY “DATA TRANSMISSION” |

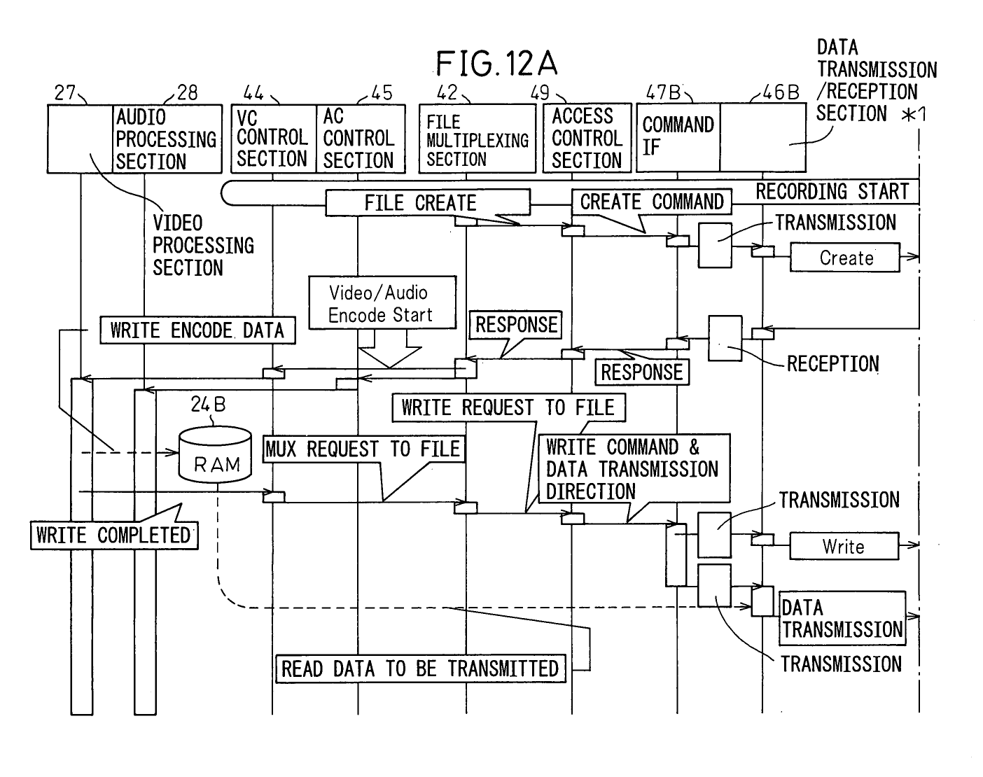

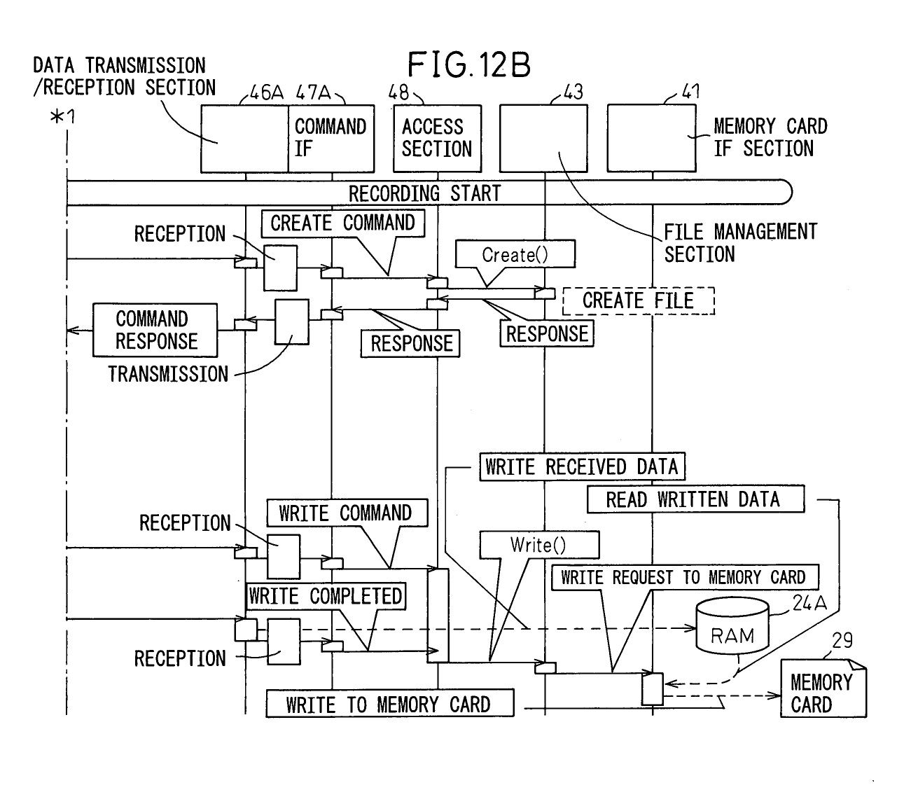

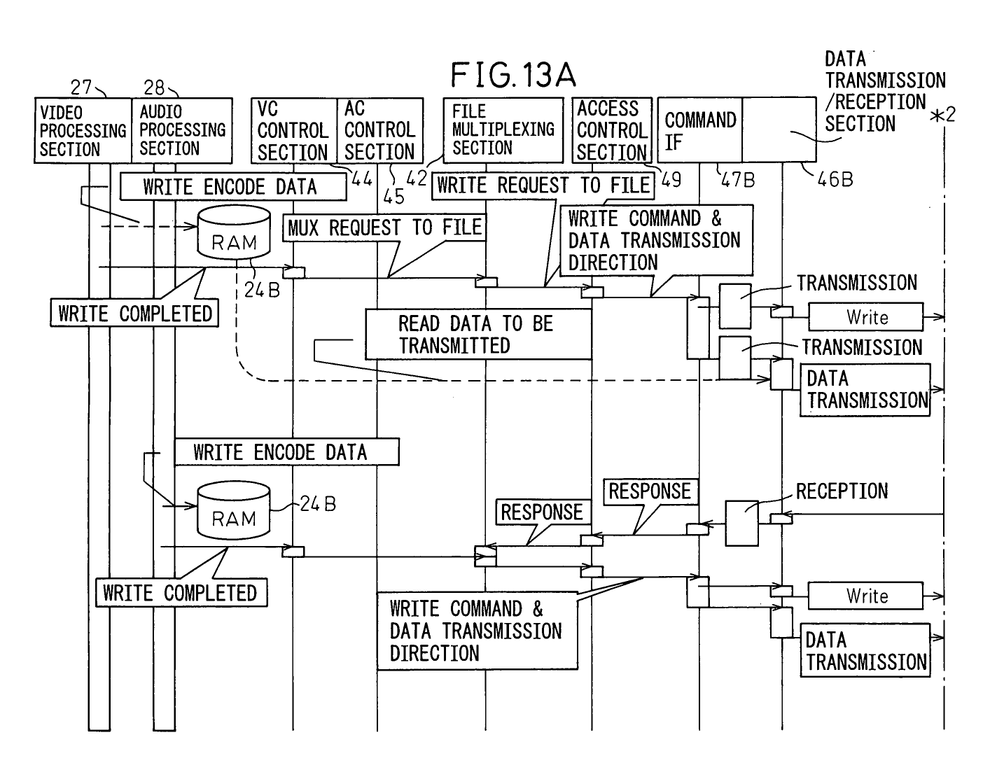

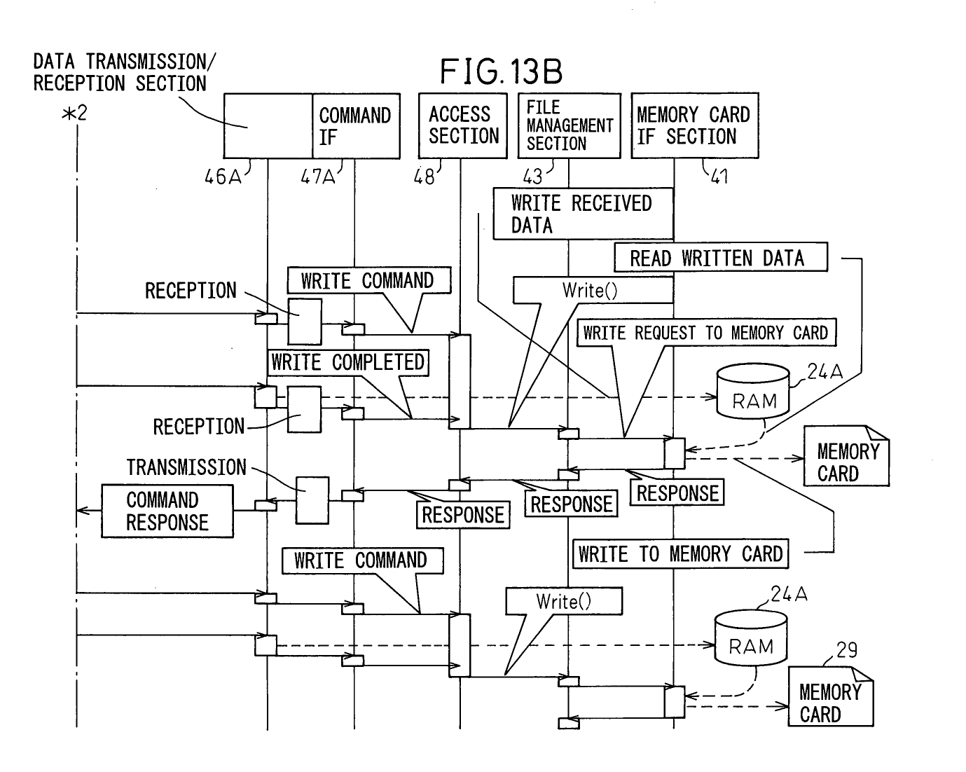

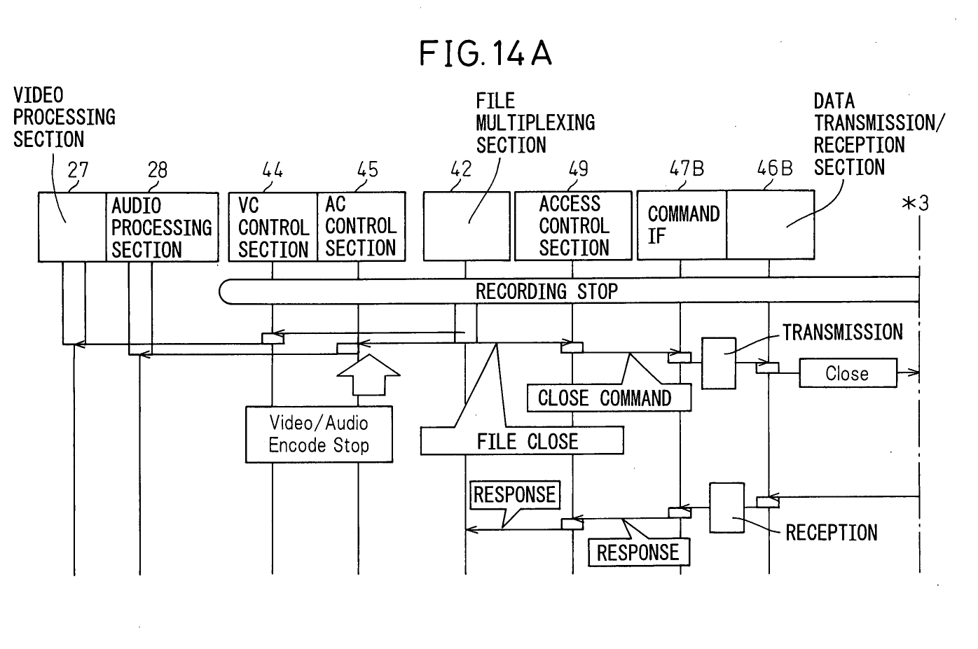

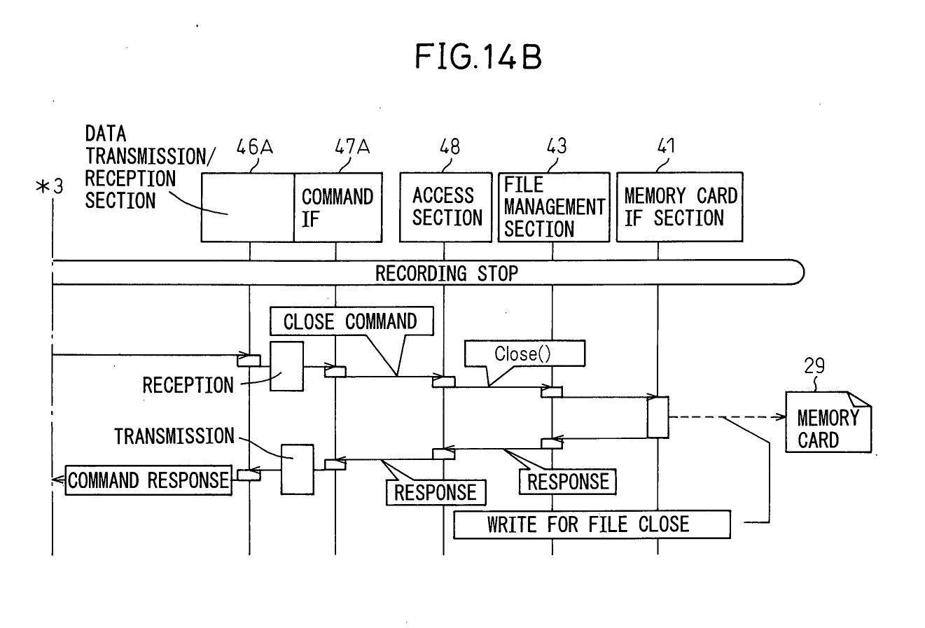

The embodiments of the present invention are explained as above. FIG. 12A to FIG. 14B are diagrams showing a processing sequence during the period of recording in more detail when utilizing the command in Table 1, wherein FIG. 12A and FIG. 12B, FIG. 13A and FIG. 13B, and FIG. 14A and FIG. 14B form diagrams, and FIG. 12A and FIG. 12B show file create processing, FIG. 13 and FIG. 13B show file write processing, and FIG. 14A and FIG. 14B show file close processing. A series of processing is explained briefly.

When the data processor 21B creates a file on the memory card 29, the file multiplexing section 42 of the data processor 21B outputs a CREATE command to the access control section 49 as shown in FIG. 12A and FIG. 12B. The access control section 49 transmits the CREATE command to the access section 48 via the command IF section 47B, the data transmission/reception section 46B, the data transmission/reception section 46A, and the command IF section 47A. The access command 48 requests the file management section 43 to create a new file and the file management section 43 sends back a response that creation is complete after creating a file. The access section 48 notifies the file multiplexing section 42 of the completion of file creation via the command IF section 47B, the data transmission/reception section 46B, the data transmission/reception section 46A, the command IF section 47A, and the access control section 49. The file multiplexing section 42 registers the information of the created file.

Next, the file multiplexing section 42 directs the video processing section 27 and the audio processing section 28 to start encoding via the VC control section 44 and the AC control section 45. In response to this, the video processing section 27 encodes RGB image data and generates MPEG4 data and the audio processing section 28 encodes PCM audio data and generates MP2 data, and stores the data in the RAM 24B. The VC control section 44 and the AC control section 45 request the file multiplexing section 42 to perform multiplexing processing of the MPEG4 data and the MP2 data into a file. The file multiplexing section 42 adds information for multiplexing data and requests the access control section 49 to perform write processing. At this time, the data stored in the RAM 24B is transmitted to the RAM 32B. The access control section 49 transmits a WRITE command to the access section 48 via the command IF section 47B, the data transmission/reception section 46B, the data transmission/reception section 46A, and the command IF section 47A. The access section 48 starts data reception, sequentially stores the transmitted data in the RAM 32A, and further, transmits the data in the RAM 32A to the RAM 24A when the condition is such that the load of the internal bus 32A is light. Incidentally, the amount of data to be transmitted in one time is determined in advance and data is transmitted in the units of blocks.

When transmission of data is completed, the access section 48 requests the file management section 43 to write data to the memory card 29. The file management section 43 reads data from the RAM 24 when the condition is such that the load of the internal bus 32A is light and writes data to the file on the memory card 29 via the memory card IF section 41.

Data transmission from the RAM 24B to the RAM 24A and data write to the memory card 29 are performed in parallel with the encode processing in the video processing section 27 and the audio processing section 28.

The first half of the write processing of a file shown in FIG. 13A and FIG. 13B is the same as the processing shown in FIG. 12A and FIG. 12B described above. When the writing of one block to the memory card 29 is completed, a response of completion is sent out from the file management section 43 to the file multiplexing section 42. In response to this, the file multiplexing section 42 starts transmission of data of the next block. After this, the processing explained in FIG. 12A and FIG. 12B is repeated until the writing of all the data to the memory card 29 is completed as shown in FIG. 13A and FIG. 13B.

When the encode processing in the video processing section 27 and the audio processing section 28 is completed and the write of data to the memory card 29 is completed, the file multiplexing section 42 outputs a CLOSE command to the access control section 49 as shown in FIG. 14A and FIG. 13B. The access control section 49 transmits the CLOSE command to the access section 48 via the command IF section 47B, the data transmission/reception section 46B, the data transmission/reception section 46A, and the command IF section 47A. The access section 48 requests the file management section 43 to close a new file and the file management section 43 performs close processing of a file on the memory card 29 via the memory card IF section 41 and sends back a response that the file close processing is completed to the access section 48. The access section 48 sends the response that the file close processing is completed to the file multiplexing section 42 via the command IF section 47B, the data transmission/reception section 46B, the data transmission/reception section 46A, the command IF section 47A, and the access control section 49 and the file multiplexing section 42 registers the closing of a file.

The embodiments of the present invention are described as above, however, it is apparent that there can be various modification examples. The present invention can be applied to a system that utilizes a multiprocessor in which data processors are connected with each another by a communication path.

1. A multiprocessor system comprising at least two data processors having a processing unit and an internal bus, wherein:
a first data processor, which is one of the data processors, comprises a memory card interface connected to the internal bus and is capable of accessing a memory card via the memory card interface;
the first data processor comprises a first communication interface for communication with another data processor and a first buffer for temporarily storing data to be transmitted and received by the first communication interface;
the other processor comprises a second communication interface for communication with the first communication interface;
when the other data processor reads data stored in the memory card, the first data processor, after reading the data stored in the memory card in accordance with the condition of processing of the first data processor and storing the data in the first buffer temporarily, transmits the data stored in the first buffer to the other data processor via the first communication interface irrespective of the condition of processing of the first data processor; and
when the other data processor writes data to the memory card, the first data processor, after receiving data from the other data processor via the first communication interface and storing the data in the first buffer irrespective of the condition of processing of the first data processor, and reading the data stored in the memory card in accordance with the condition of processing of the first data processor and storing the data in the first buffer temporarily, writes the data stored in the buffer to the memory card in accordance with the condition of processing of the first data processor.

2. The multiprocessor system as set forth in claim 1, wherein the other data processor comprises a second buffer for temporarily storing data to be transmitted and received by the second communication interface.

3. The multiprocessor system as set forth in claim 1, wherein:
the first data processor comprises an access section for performing processing to access the memory card;
the other data processor comprises an access control section for performing processing to access the memory card; and
when accessing the memory card, the other data processor activates the access section from the access control section via the first and second communication interfaces and accesses the memory card via the access section.

4. The multiprocessor system as set forth in any of claims 1 to 3, wherein:
the first data processor comprises a file management section for managing files on the memory card; and
when accessing the file on the memory card, the other data processor sends a command to, and activates the file management section of, the first data processor via the first and second communication interfaces.

5. The multiprocessor system as set forth in claim 3, wherein the other data processor is capable of creating the file on the memory card.

6. A multiprocessor system comprising at least two data processors having a processor and an internal bus, wherein:
a first data processor, which is one of the data processors, comprises a memory card interface connected to the internal bus and is capable of accessing a memory card via the memory card interface;
the first data processor and another data processor comprise communication interfaces for communication with each other, respectively;
the first data processor comprises an access section for performing processing to access the memory card;
the other data processor comprises an access control section for performing processing to access the memory card; and
when accessing the memory card, the other data processor activates the access section from the access control section via the communication interface and accesses the memory card via the access section.

7. The multiprocessor system as set forth in claim 5, wherein:
the first data processor comprises a file management section for managing files on the memory card; and
when accessing the file on the memory card, the other data processor sends a command to, and activates the file management section of, the first data processor via the communication interface.

8. The multiprocessor system as set forth in claim 6, wherein the other data processor is capable of creating a file on the memory card.

9. A multiprocessor system comprising at least two data processors having a processor and an internal bus, wherein:
a first data processor, which is one of the data processors, comprises a memory card interface connected to the internal bus and is capable of accessing a memory card via the memory card interface;
the first data processor and another data processor comprise communication interfaces for communication with each other, respectively;
the first data processor comprises a file management section for managing files on the memory card; and
when accessing the file on the memory card, the other data processor sends a command to, and activates the file management section of, the first data processor via the communication interface.

10. The multiprocessor system as set forth in claim 9, wherein the other data processor is capable of creating a file on the memory card.
